(19) United States
(12) Patent Application Publication
(10) Pub. No.: US 2024/0312704 A1
(43) Pub. Date: Sep. 19, 2024

(54) METHOD OF PRODUCING SmFeN-BASED RARE EARTH MAGNET

(71) Applicants: TOYOTA JIDOSHA KABUSHIKI KAISHA, Toyota-shi (JP); NICHIA CORPORATION, Anan-shi, Tokushima (JP)

(72) Inventors: Tomonori INUZUKA, Toyota-shi (JP); Masaaki ITO, Anjo-shi (JP); Motoki HIRAOKA, Toyota-shi (JP); Hisashi MAEHARA, Itano-gun (JP)

(21) Appl. No.: 18/600,937

(22) Filed: Mar. 11, 2024

(30) Foreign Application Priority Data
Mar. 14, 2023 (JP) 2023-039197

(51) Int. Cl. H01F 41/02; B22F 1/00; B22F 1/052; B22F 1/145; B22F 1/16; B22F 3/16; B22F 3/24; H01F 1/059

(52) U.S. Cl. CPC H01F 41/0266; B22F 1/052; B22F 1/09; B22F 1/145; B22F 1/16; B22F 3/16; B22F 3/24; H01F 1/059; B22F 2003/248; B22F 2201/20; B22F 2202/05; B22F 2301/35; B22F 2304/10; B22F 2998/10; B22F 2999/00

(57) ABSTRACT

A method of producing a SmFeN-based rare earth magnet having excellent magnetic properties is provided.

The present disclosure relates to a method of producing a SmFeN-based rare earth magnet in which a powder having a large particle size and a powder having a small particle size are used as SmFeN-based anisotropic magnetic powders, and the powders are separately dry treated at temperatures appropriate for the respective particle sizes when the powders are surface treated using phosphoric acid source to perform phosphoric acid coating.

### CROSS REFERENCE TO RELATED APPLICATIONS

The present application claims priority from Japanese patent application JP 2023-039197 filed on Mar. 14, 2023, the entire content of which is hereby incorporated by reference into this application.

### BACKGROUND

### Technical Field

The present disclosure relates to a method of producing a SmFeN-based rare earth magnet.

### Description of Related Art

As a rare earth magnet exhibiting high performance, a Sm—Co-based rare earth magnet and a Nd—Fe—B-based rare earth magnet have been in practical use, but in recent years, rare earth magnets other than these have been examined.

For example, JP 2020-053437 A discloses a rare earth magnet including a main phase containing Sm, Fe, and N with at least a part of the main phase having a Th₂Zn₁₇ type or Th₂Ni₁₇ type crystal structure, a subphase containing Zn and Fe and is present around the main phase, and an intermediate phase containing Sm, Fe, N, and Zn, and is present between the main phase and the subphase. The average content of Fe in the subphase is 33 atomic % or less with respect to the entire subphase.

### SUMMARY

The present disclosure provides a method of producing a SmFeN-based rare earth magnet having excellent magnetic properties.

As means of enhancing the coercive force of a SmFeN-based rare earth magnet, there is a method of surface treating the particle surfaces of a SmFeN-based anisotropic magnetic powder, which serves as the raw material of the magnet, using zinc (Zn) and/or phosphoric acid source. In particular, the surface treatment using phosphoric acid source provides an effect of suppressing precipitation of α-Fe during low temperature pressure sintering and heat treatment.

However, the present inventors have discovered that, depending on the drying temperature when coating the particle surfaces of the SmFeN-based anisotropic magnetic powder with phosphoric acid, a modification reaction between Fe and Zn on the particle surfaces might possibly be inhibited. As a result, the residual magnetic flux density and the coercive force of a bulk body might also have a low value.

Therefore, as a result of examining various means for solving the problem, the present inventors have discovered the following and completed the present disclosure. In the method of producing a SmFeN-based rare earth magnet, by using a powder having a large particle size (large particle powder) and a powder having a small particle size (small particle powder) as the SmFeN-based anisotropic magnetic powders, and dry treating the large particle powder and the small particle powder separately at temperatures appropriate for the respective particle sizes when surface treating the large particle powder and the small particle powder using phosphoric acid source to perform the phosphoric acid coating, the SmFeN-based rare earth magnet obtained later exhibits high coercive force.

That is, the gist of the present disclosure is as follows.
(1) A method of producing a SmFeN-based rare earth magnet, comprising:
(i) a raw material preparing step of preparing a first SmFeN-based anisotropic magnetic powder having a 50% particle size in a cumulative particle size distribution on a volumetric basis (D₅₀) of 3.0±0.3 μm, and a second SmFeN-based anisotropic magnetic powder having D₅₀ of 1.6±0.3 μm;
(ii) a drying step of subjecting to a phosphoric acid source treatment and drying at a temperature of 80° C. or more and less than 150° C. with respect to the first SmFeN-based anisotropic magnetic powder to obtain a first phosphoric acid-coated SmFeN-based anisotropic magnetic powder;
(iii) a drying step of subjecting to a phosphoric acid source treatment and drying at a temperature of 150° C. or more and 250° C. or less with respect to the second SmFeN-based anisotropic magnetic powder to obtain a second phosphoric acid-coated SmFeN-based anisotropic magnetic powder;
(iv) a mixing step of mixing the first phosphoric acid-coated SmFeN-based anisotropic magnetic powder obtained in the step (ii), the second phosphoric acid-coated SmFeN-based anisotropic magnetic powder obtained in the step (iii), and a modifier powder containing Zn to prepare a powder mixture;
(v) a compression molding step of compression molding the powder mixture obtained in the step (iv) in a magnetic field to obtain a magnetic field molded body; and
(vi) a sintering step of pressure sintering the magnetic field molded body obtained in the step (v) to obtain a sintered body.

(2) The method according to (1) in which, in the step (iv), a mass ratio between the first phosphoric acid-coated SmFeN-based anisotropic magnetic powder and the second phosphoric acid-coated SmFeN-based anisotropic magnetic powder (first phosphoric acid-coated SmFeN-based anisotropic magnetic powder:second phosphoric acid-coated SmFeN-based anisotropic magnetic powder) is 8:2 to 9:1.

(3) The method according to (1) or (2) in which, in the step (ii), the temperature of drying is 80° C. or more and 140° C. or less.

(4) The method according to any one of (1) to (3) in which, in the step (iii), the temperature of drying is 160° C. or more and 220° C. or less.

The present disclosure provides a method of producing a SmFeN-based rare earth magnet having excellent magnetic properties.

### BRIEF DESCRIPTION OF THE DRAWINGS

FIG. 1 is a drawing schematically illustrating a state of a powder mixture;

FIG. 2 is a drawing schematically illustrating one example of a method of the present disclosure;

FIG. 3 is a graph indicating a relation between a drying temperature of phosphoric acid and a magnetization of magnetic powder and a coercive force of magnetic powder of a SmFeN-based anisotropic magnetic powder having D₅₀ of 3.1 μm; and

FIG. 4 is a graph indicating a relation between coercive forces and residual magnetic flux densities Br in SmFeN-based rare earth magnets obtained in Comparative Examples 1 and 2, and Example 1.

### DETAILED DESCRIPTION OF THE EMBODIMENTS

The following describes some embodiments of the present disclosure in detail. In the present description, features of the present disclosure will be described with reference to the drawings as necessary. In the drawings, dimensions and shapes of respective components are exaggerated for clarification, and actual dimensions and shapes are not accurately illustrated. Accordingly, the technical scope of the present disclosure is not limited to the dimensions or the shapes of the respective components illustrated in these drawings. Note that a method of producing a SmFeN-based rare earth magnet of the present disclosure is not limited to the embodiments below, and can be performed in various configurations in which changes, improvements, and the like that a person skilled in the art can make are given without departing from the gist of the present disclosure. Moreover, in the present disclosure, the term “step” encompasses not only an independent step but also a step that is not clearly distinguished from other steps, as long as a desired object of the step is achieved.

In a step (i) (raw material preparing step), a first SmFeN-based anisotropic magnetic powder having a 50% particle size in a cumulative particle size distribution on a volumetric basis (hereinafter, also referred to as D₅₀ or median size) of 3.0±0.3 μm, such as 3.1 μm, and a second SmFeN-based anisotropic magnetic powder having D₅₀ of 1.6±0.3 μm, such as 1.5 μm, are prepared.

Here, D₅₀ (median size) is a particle size in which an integrated value of a particle size distribution on a volumetric basis of a target powder is equivalent to 50%, and can be measured by a dry laser diffraction/scattering method.

As the first and second SmFeN-based anisotropic magnetic powders, SmFeN-based anisotropic magnetic powders that are the same except for D₅₀ can be used. As the SmFeN-based anisotropic magnetic powder, for example, a SmFeN-based anisotropic magnetic powder expressed as follows can be used.

SmᵥFe_{(100-v-w-x-y-z-u)}N_{w}LaₓW_{y}Ti_{z}

(In the formula, 3≤v≤30, 5≤w≤15, 0≤x≤0.3, 0≤y≤2.5, and 0≤z≤2.5 are satisfied.) The reason for specifying v as 3 or more and 30 or less in the general formula is because, when v is less than 3, an unreacted part of iron component (α-Fe phase) becomes separated, which reduces the coercive force of the SmFeN-based anisotropic magnetic powder and thus fail to provide a practical magnet, and when v is more than 30, the Sm element precipitates and makes the SmFeN-based anisotropic magnetic powder unstable in the air, thereby reducing the residual magnetic flux density. In addition, the reason for specifying w as 5 or more and 15 or less is because, when w is less than 5, almost no coercive force can be obtained, and when w is more than 15, a nitride of Sm and/or iron itself is formed.

As the SmFeN-based anisotropic magnetic powder, SmFeN, SmFcLaN, SmFeLaWN, and SmFeLaWRN (in the formula, R is at least one kind selected from the group consisting of Ti, Ba, and Sr) are used in some embodiments. In addition, a mixture of an anisotropic magnetic powder containing SmFeLaWN and an anisotropic magnetic powder containing SmFeLaWTiN may be used. The SmFeN-based anisotropic magnetic powder containing R has excellent magnetic properties and thus is used as the first SmFeN-based anisotropic magnetic powder in which a mixture ratio thereof can be made particularly high in some embodiments.

In view of the residual magnetic flux density, when the SmFeN-based anisotropic magnetic powder contains La, the content of La is usually 0.1 mass % or more and 5 mass % or less, and is 0.15 mass % or more and 1 mass % or less in some embodiments.

In view of the coercive force and the squareness ratio, when the SmFeN-based anisotropic magnetic powder contains W, the content of W is usually 0.1 mass % or more and 5 mass % or less, and is 0.15 mass % or more and 1 mass % or less in some embodiments.

In view of the temperature characteristics, when the SmFEN-based anisotropic magnetic powder contains R (R is at least one kind selected from the group consisting of Ti, Ba, and Sr), the content of R is usually 0.1 mass % or more and 5 mass % or less, and is 0.15 mass % or more and 1 mass % or less in some embodiments.

The content of N in the SmFeN-based anisotropic magnetic powder is usually 3.3 mass % or more and 3.5 mass % or less. When the content of N is more than 3.5 mass %, excessive nitridation occurs. When the content of N is less than 3.3 mass %, insufficient nitridation occurs. In both the cases, the magnetic properties tend to decrease.

The SmFeN-based anisotropic magnetic powder can be produced by referring to methods disclosed in, for example, JP 2017-117937 A and JP 2021-055188 A.

In a step (ii) (drying step), the first SmFeN-based anisotropic magnetic powder is subjected to a phosphoric acid source treatment and dried to obtain a first phosphoric acid-coated SmFeN-based anisotropic magnetic powder.

The phosphoric acid source treatment for the first SmFEN-based anisotropic magnetic powder can be performed by a known method in the technical field and is not limited. The phosphoric acid source treatment for the first SmFeN-based anisotropic magnetic powder can be performed as follows, for example.

In the step of treating the SmFeN-based anisotropic magnetic powder with a phosphoric acid source, by treating the SmFeN-based anisotropic magnetic powder with the phosphoric acid source, a passive film having P—O bonds is formed on the surface of the SmFEN-based anisotropic magnetic powder. By coating the SmFeN-based anisotropic magnetic powder with a film containing P and O, oxidative degradation caused by the air during processing can be suppressed.

Examples of the phosphoric acid source include: inorganic phosphoric acids, for example orthophosphoric acid, phosphates, such as sodium dihydrogen phosphate, sodium dihydrogen phosphate, ammonium dihydrogen phosphate, diammonium hydrogen phosphate, zinc phosphate, calcium phosphate, and other phosphates, hypophosphorous acids, hypophosphites, pyrophosphoric acid, and polyphosphoric acids; and organic phosphoric acids. These phosphoric acid sources are basically dissolved in water or in an organic solvent, such as IPN, and after a reaction accelerator, such as nitrate ion, or a grain refiner, such as V ion, Cr ion and/or Mo ion is, as necessary, added thereto, the SmFeN-based anisotropic magnetic powder is introduced into the phosphoric acid bath to form a passive film having P—O bonds on the particle surface of the SmFeN-based anisotropic magnetic powder. The phosphoric acid source is dissolved in water in some embodiments. Thus, compared with a case where the phosphoric acid source is dissolved in an organic solvent, carbon content of the SmFeN-based anisotropic magnetic powder can be reduced, and therefore a defect caused by an organic impurity containing carbon on the coated portion coated with phosphoric acid is less likely to occur and a reduction in the coercive force of the SmFeN-based anisotropic magnetic powder can be suppressed. In addition, for a similar reason, the phosphoric acid source is an inorganic phosphoric acid in some embodiments. The phosphoric acid source treatment may be performed while stirring a slurry containing the SmFeN-based anisotropic magnetic powder.

The amount of phosphoric acid introduced in the step (ii) is not limited. The amount of phosphoric acid introduced in the step (ii) is, as PO₄, usually 0.20 mass % or more and 3.0 mass % or less, and 0.50 mass % or more and 1.5 mass % or less in some embodiments with respect to the first SmFeN-based anisotropic magnetic powder.

Furthermore, in the step (ii), the SmFeN-based anisotropic magnetic powder having been subjected to the phosphoric acid source treatment is dried at a temperature of 80° C. or more and less than 150° C., or at a temperature of 80° C. or more and 140° C. or less in some embodiments, for example under reduced pressure or in vacuum. Note that, when the temperature is less than 80° C., water content might remain in the SmFeN-based anisotropic magnetic powder and the magnetic properties possibly decrease.

The drying time in the step (ii) is not limited, and can be appropriately determined such that the water content in the SmFeN-based anisotropic magnetic powder is removed and, as described below, the surface of the SmFeN-based anisotropic magnetic powder and phosphorus are chemically bonded. Note that the drying time excludes the time required to increase the temperature to the drying temperature (temperature of drying). The drying time may be, for example, 1 minute or more, 2 minutes or more, or 3 minutes or more, and may be 200 minutes or less, 60 minutes or less, or 30 minutes or less with respect to 100 g of the first SmFeN-based anisotropic magnetic powder.

In the drying step, in addition to coating the surface of the SmFeN-based anisotropic magnetic powder with phosphoric acid, phosphorus can be chemically bonded by the drying heat. In addition, by the phosphorus being chemical bonded by the drying, in the step of applying heat to the SmFeN-based anisotropic magnetic powder after a step (v), Zn contained in a modifier powder can be suppressed from being oxidized to ZnO.

In the step (ii), by drying the first SmFeN-based anisotropic magnetic powder that has been subjected to the phosphoric acid source treatment at the temperature in the above-described range, the phosphoric acid coating can be performed in a state where the particle surface of the SmFeN-based anisotropic magnetic powder has certain amounts of clearances.

In a step (iii) (drying step), the second SmFeN-based anisotropic magnetic powder is subjected to a phosphoric acid source treatment and dried to obtain a second phosphoric acid-coated SmFeN-based anisotropic magnetic powder.

The phosphoric acid source treatment for the second SmFeN-based anisotropic magnetic powder in the step (iii) can be performed by a known method in the technical field, and is not limited. The phosphoric acid source treatment for the second SmFeN-based anisotropic magnetic powder in the step (iii) can be performed, for example, similarly to the phosphoric acid source treatment for the first SmFeN-based anisotropic magnetic powder in the step (ii) as described above.

The amount of phosphoric acid introduced in the step (iii) is not limited. The amount of phosphoric acid introduced in the step (iii) is, as PO₄, usually 0.20 mass % or more and 3.0 mass % or less, and 0.50 mass % or more and 1.5 mass % or less in some embodiments with respect to the second SmFeN-based anisotropic magnetic powder.

Furthermore, the SmFeN-based anisotropic magnetic powder having been subjected to the phosphoric acid source treatment in the step (iii) is dried at a temperature of 150° C. or more and 250° C. or less, or at a temperature of 160° C. or more and 220° C. or less in some embodiments, for example under reduced pressure or in vacuum.

The drying time in the step (iii) is not limited, and can be appropriately determined such that the water content in the SmFeN-based anisotropic magnetic powder is removed and, as described below, the surface of the SmFeN-based anisotropic magnetic powder and phosphorus are chemically bonded. Note that the drying time excludes the time required to increase the temperature to the drying temperature. The drying time may be, for example, 1 minute or more, 2 minutes or more, or 3 minutes or more, and may be 200 minutes or less, 60 minutes or less, or 30 minutes or less with respect to 100 g of the second SmFeN-based anisotropic magnetic powder.

In the step (iii), by drying the second SmFeN-based anisotropic magnetic powder that has been subjected to the phosphoric acid source treatment at the temperature in the above-described range, the phosphoric acid coating can be performed in a state where a large part of the particle surface of the SmFeN-based anisotropic magnetic powder does not have a clearance. Also, in the drying step, in addition to coating the surface of the SmFeN-based anisotropic magnetic powder with phosphoric acid, phosphorus can be chemically bonded by the drying heat. By the phosphorus being chemical bonded by the drying, in the step of applying heat to the SmFeN-based anisotropic magnetic powder after the step (v), Zn contained in the modifier powder can be suppressed from being oxidized to ZnO. Moreover, at the drying temperature in the step (iii), a phosphoric acid film reacts on the surface of magnetic particles of the SmFeN-based anisotropic magnetic powder and forms a non-magnetic phase, thus allowing the coercive force of the magnetic particles of the SmFEN-based anisotropic magnetic powder to be enhanced.

Note that, the step (ii) and the step (iii) are each independent steps, and the order thereof is not limited.

In a step (iv) (mixing step), the first phosphoric acid-coated SmFeN-based anisotropic magnetic powder obtained in the step (ii), the second phosphoric acid-coated SmFeN-based anisotropic magnetic powder obtained in the step (iii), and a modifier powder containing Zn are mixed to prepare a powder mixture.

The mass ratio between the first phosphoric acid-coated SmFeN-based anisotropic magnetic powder and the second phosphoric acid-coated SmFeN-based anisotropic magnetic powder (first phosphoric acid-coated SmFeN-based anisotropic magnetic powder:second phosphoric acid-coated SmFeN-based anisotropic magnetic powder) is not limited, but is usually 8:2 to 9:1, and 8.5:1.5 to 9:1, such as 8.7:1.3, in some embodiments.

By setting the mass ratio between the first phosphoric acid-coated SmFeN-based anisotropic magnetic powder and the second phosphoric acid-coated SmFeN-based anisotropic magnetic powder in the above-described range, a packing density of the powder mixture can be made high and, as a result, the residual magnetic flux density and the coercive force of the SmFeN-based rare earth magnet can be enhanced.

Examples of the modifier powder containing Zn includes zinc and zinc alloys.

In view of the residual magnetization, the upper limit of the combined amount of the modifier powder containing Zn with respect to the total mass of the first and second phosphoric acid-coated SmFeN-based anisotropic magnetic powders is, for example, 15 mass % or less in some embodiments, 10 mass % or less in some embodiments, and 7 mass % or less in some embodiments. The lower limit thereof can be 1 mass % or more, for example.

When the zinc alloy is represented by Zn-M², an element that is alloyed with zinc (Zn) to drop the melting start temperature of the zinc alloy below the melting point of Zn, and an unavoidable impurity element can be selected as M². Thus, the sinterability in the later described pressure sintering step is enhanced. M² that drops the melting start temperature below the melting point of Zn includes an element that forms a eutectic alloy between Zn and M², and the like. Such M² typically includes, for example, tin (Sn), magnesium (Mg), aluminum (Al), a combination of these, and the like. An element that does not inhibit the melting point dropping action of these elements as well as the properties of the product can also be selected as M². Incidentally, the unavoidable impurity element indicates an impurity element that is inevitably included or causes a significant rise in the production cost to avoid its inclusion, such as impurities contained in raw materials of the modifier powder containing Zn.

In the zinc alloy represented by Zn-M², the ratio (molar ratio) of Zn and M² may be appropriately determined to give an appropriate sintering temperature. The ratio (molar ratio) of M² to the entire zinc alloy may be, for example, 0.05 or more, 0.10 or more, or 0.20 or more, and may be 0.90 or less, 0.80 or less, 0.70 or less, 0.60 or less, 0.50 or less, 0.40 or less, or 0.30 or less.

The median size of the modifier powder containing Zn is not particularly limited, and may be 0.1 μm or more, 0.5 μm or more, 1 μm or more, or 2 μm or more, and may be 12 μm or less, 11 μm or less, 10 μm or less, 9 μm or less, 8 μm or less, 7 μm or less, 6 μm or less, 5 μm or less, or 4 μm or less. Here, the median size is a particle size in which an integrated value of a particle size distribution on a volumetric basis of the modifier powder containing Zn is equivalent to 50%. The median size can be measured by a dry laser diffraction/scattering method.

In some embodiments, the oxygen content of the modifier powder containing Zn is small, which allows much oxygen in the SmFeN powder to be absorbed. The oxygen content of the modifier powder containing Zn is 5.0 mass % or less in some embodiments, 3.0 mass % or less in some embodiments, and 1.0 mass % or less in some embodiments, with respect to the total mass of the modifier powder containing Zn. On the other hand, for extremely reducing the oxygen content of the modifier powder containing Zn, an increase in the production cost is caused. For this reason, the oxygen content of the modifier powder containing Zn may be 0.1 mass % or more, 0.2 mass % or more, or 0.3 mass % or more, with respect to the total mass of the modifier powder containing Zn.

The mixing method in the step (iv) can be performed by a known method in the technical field, and is not limited.

Examples of the mixing method can include a wet method, a dry method, or a combination of these. Examples of the mixing method include methods using a mortar, a muller wheel mixer, an agitator mixer, a mechano-fusion system, a V-mixer, a bead mill, or a ball mill. A method using these devices in combination can also be used. Note that, V-mixer refers to an apparatus equipped with a vessel including two cylindrical vessels connected in a V shape in which the vessel may be rotated to repeatedly gather and separate the powder in the vessel by gravity and centrifugal force, thereby mixing the powder.

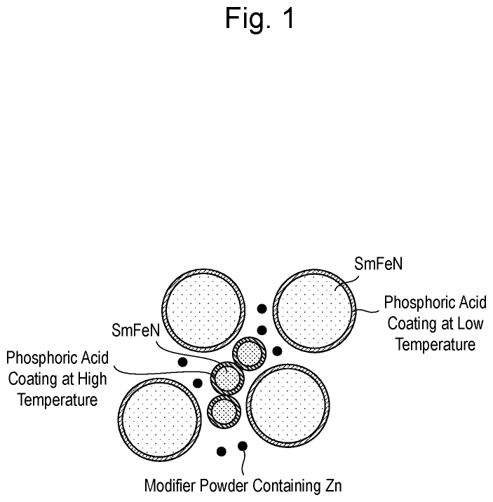

By the step (iv), the first phosphoric acid-coated SmFeN-based anisotropic magnetic powder obtained in the step (ii), the second phosphoric acid-coated SmFeN-based anisotropic magnetic powder obtained in the step (iii), and the modifier powder containing Zn are uniformly dispersed and mixed. FIG. 1 schematically illustrates the state of the powder mixture.

In the step (v) (compression molding step), the powder mixture obtained in the step (iv) is compression molded in the magnetic field to obtain the magnetic field molded body.

In the compression molding step, the magnetic field orientation imparts orientation to the magnetic field molded body and thus imparts anisotropy to the SmFeN-based rare earth magnet to allow enhancing the residual magnetization. The magnetic field molding can be performed by known methods, such as compression molding the powder mixture using a molding die and a magnetic field generator located around the die. The molding pressure may be 10 MPa or more, 20 MPa or more, 30 MPa or more, 50 MPa or more, 100 MPa or more, or 150 MPa or more, and may be 1,500 MPa or less, 1,000 MPa or less, or 500 MPa or less. The magnitude of the magnetic field to be applied may be 500 kA/m or more, 1,000 kA/m or more, 1,500 kA/m or more, or 1,600 kA/m or more, and may be 20,000 kA/m or less, 15,000 kA/m or less, 10,000 kA/m or less, 5,000 kA/m or less, 3,000 kA/m or less, or 2,000 kA/m or less. The application method of the magnetic field may be performed, for example, by applying a static magnetic field using an electromagnet or by applying an alternating pulsed magnetic field.

The temperature of the step (v) is not limited, but is usually 10° C. to 40° C., and is 20° C. to 30° C. in some embodiments.

In a step (vi) (sintering step), the magnetic field molded body obtained in the step (v) is pressure sintered to obtain a sintered body.

In the sintering step, the obtained sintered body can be directly used as the SmFeN-based rare earth magnet. The pressure sintering is not limited to a particular method, and may be performed by, for example, providing a die having a cavity and a punch capable of sliding within the cavity, inserting the magnetic field molded body into the cavity, and sintering the magnetic field molded body while applying a pressure to the magnetic field molded body using the punch. As the pressure sintering method, for example, a Spark Plasma Sintering (SPS) can be used. The pressure sintering conditions can be appropriately selected so as to be able to sinter the magnetic field molded body while applying a pressure to the magnetic field molded body (hereinafter, also referred to as “pressure sinter”). When the sintering temperature is 300° C. or more, Fe on the particle surface of the SmFeN-based anisotropic magnetic powder and the modifier powder (for example, metallic zinc) can be slightly interdiffused in the magnetic field molded body, thereby contributing to sintering. For example, the sintering temperature may be 310° C. or more, 320° C. or more, 340° C. or more, or 350° C. or more. On the other hand, when the sintering temperature is 400° C. or less, the Fe on the particle surface of the SmFeN-based anisotropic magnetic powder and the modifier powder can be suppressed from being excessively interdiffused. Therefore, difficulties in the heat treatment step described later and adverse effects on the magnetic properties of the obtained sintered body can be suppressed. From these viewpoints, the sintering temperature may be 400° C. or less, 390° C. or less, 380° C. or less, or 370° C. or less.

In the first phosphoric acid-coated SmFeN-based anisotropic magnetic powder of the present disclosure, the particle size is larger compared with the particle size of the second phosphoric acid-coated SmFeN-based anisotropic magnetic powder, and the particle surface of the SmFeN-based anisotropic magnetic powder is coated with phosphoric acid in a state where the particle surface has certain amounts of clearances. Therefore, interdiffusion between Fe on the particle surface and Zn contained in the modifier powder occurs appropriately and forms a fluidized bed. As a result, the coercive force of the SmFeN-based rare earth magnet can be enhanced. Here, the fluidized bed is a bed formed by Zn that is liquidized at the time of sintering, and the fluidized bed allows suppressing excessive pressure to be applied to the magnetic particles at the time of sintering, and avoiding cracking of the magnetic particles or distortion of the crystal structure.

On the other hand, in the second phosphoric acid-coated SmFeN-based anisotropic magnetic powder, since the particle size is smaller compared with the particle size of the first phosphoric acid-coated SmFeN-based anisotropic magnetic powder and thus aggregation occurs easily, a modification reaction by the interdiffusion with Zn is unlikely to occur originally. Therefore, in the second phosphoric acid-coated SmFeN-based anisotropic magnetic powder, since the particle surface of the SmFeN-based anisotropic magnetic powder is coated with phosphoric acid in a state where a large part of the particle surface has no clearance, the interdiffusion between Fe on the particle surface and Zn contained in the modifier powder is unlikely to occur, and the modification reaction is unlikely to be caused. However, as described above in the step (iii), due to the performance of enhancing the coercive force derived from phosphoric acid itself coated on the particle surface, the coercive force of the SmFeN-based rare earth magnet can be enhanced as a result.

The sintering pressure can be appropriately selected from a sintering pressure that can increase the density of the sintered body. The sintering pressure may typically be 100 MPa or more, 200 MPa or more, 400 MPa or more, 600 MPa or more, and may be 2,000 MPa or less, 1,800 MPa or less, 1,600 MPa or less, 1,500 MPa or less, 1,300 MPa or less, or 1,200 MPa or less.

The sintering time can be appropriately determined such that the Fe on the particle surface of the phosphoric acid-coated SmFeN-based anisotropic magnetic powder and the metallic zinc of the modifier powder can be slightly interdiffused. Here, the sintering time excludes the time required to increase the temperature to the heat treatment temperature. For example, the sintering time may be 1 minute or more, 2 minutes or more, or 3 minutes or more, and may be 90 minutes or less, 60 minutes or less, or 30 minutes or less. The sintering time may also be 20 minutes or less, 10 minutes or less, or 5 minutes or less.

Once the sintering time has elapsed, the sintered body is cooled to terminate the sintering. A faster cooling rate can more suppress oxidation or other reaction of the sintered body. For example, the cooling rate may be 0.5° C./sec or more and 200° C./sec or less. The sintering atmosphere is an inert gas atmosphere in order to suppress oxidation of the magnetic field molded body and the sintered body in some embodiments. Examples of the inert gas atmosphere include a nitrogen gas atmosphere.

The method of producing a SmFeN-based rare earth magnet of the present disclosure further comprises, after the step (vi), a heat treatment step of heat treating the sintered body obtained in the step (vi) to obtain the SmFeN-based rare earth magnet in some embodiments.

In the heat treatment step of the sintered body, the SmFeN-based rare earth magnet obtained by sintering is heat treated. Regarding the particles of the phosphoric acid-coated SmFeN-based anisotropic magnetic powder, particularly the first phosphoric acid-coated SmFeN-based anisotropic magnetic powder, the heat treatment forms a Fe—Zn alloy phase as a coating on the particle surface of the phosphoric acid-coated SmFeN-based anisotropic magnetic powder to further strongly bind (hereinafter, also referred to as “solidify”) the particles of the SmFeN-based anisotropic magnetic powder to the particles of the modifier powder, and simultaneously to promote modification. When the heat treatment temperature is 350° C. or more, the Fe—Zn alloy phase can be appropriately formed on almost all the particles, thereby solidifying and modifying them. The heat treatment temperature may be 360° C. or more, 370° C. or more, or 380° C. or more.

The magnetic phase of the SmFeN-based anisotropic magnetic powder has a Th₂Zn₁₇ type and/or Th₂Ni₁₇ type crystal structure, and the formation of the Fe—Zn alloy phase saturates when the heat treatment time reaches 40 hours. In view of economic efficiency (reduction in time), the heat treatment time is 40 hours or less, 35 hours or less, 30 hours or less, 25 hours or less, or 24 hours or less in some embodiments. To suppress oxidation of the sintered body, the sintered body is heat treated in vacuum or in an inert gas atmosphere in some embodiments. Here, examples of the inert gas atmosphere include a nitrogen gas atmosphere. The sintered body may be heat treated in the die used in the pressure sintering, but no pressure is applied to the sintered body during the heat treatment. Thus, as long as the above-mentioned heat treatment conditions are satisfied, normal magnetic phase and Fe—Zn alloy phase are appropriately formed, without excessive interdiffusion between Fe and Zn.

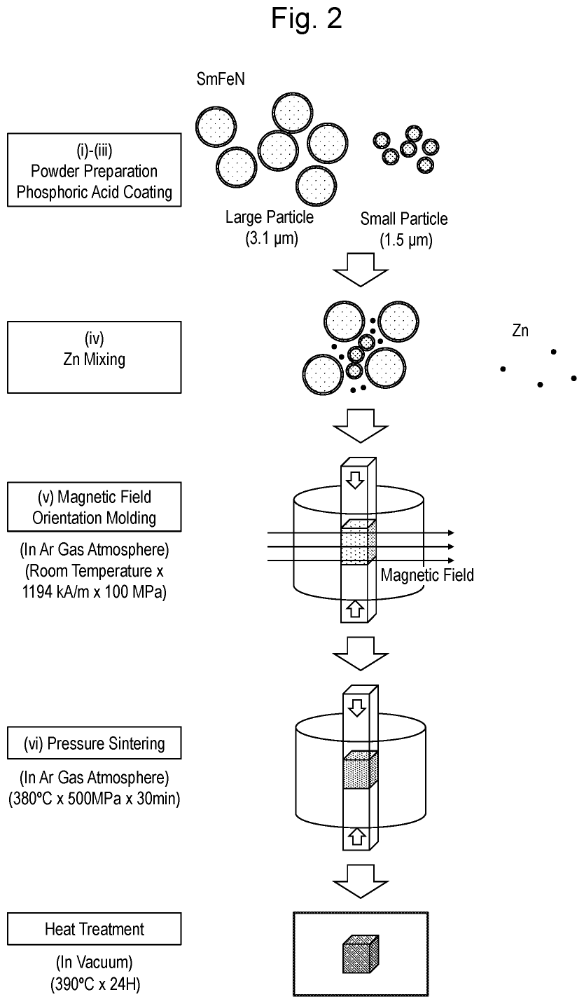

FIG. 2 schematically illustrates one example of the method of the present disclosure.

The density of the SmFeN-based rare earth magnet obtained by the method of the present disclosure is not particularly limited, but is usually 5.8 g/cm³ or more and 7 g/cm³ or less, and is 6 g/cm³ or more and 6.7 g/cm³ or less in some embodiments.

### Example

The following describes some examples related to the present disclosure but it is not intended to limit the present disclosure to the given examples.

### 1. Examination of Drying Temperature of Phosphoric Acid-Coated SmFeN-Based Anisotropic Magnetic Powder

With respect to a SmFeN-based anisotropic magnetic powder having D₅₀ of 3.1 μm, 1 mass % of a phosphoric acid solution as PO₄ was introduced thereto and after stirring for 5 minutes, solid-liquid separation was performed. Then, the obtained solid body was dried for 180 minutes in vacuum at respective drying temperatures to obtain phosphoric acid-coated SmFeN-based anisotropic magnetic powders.

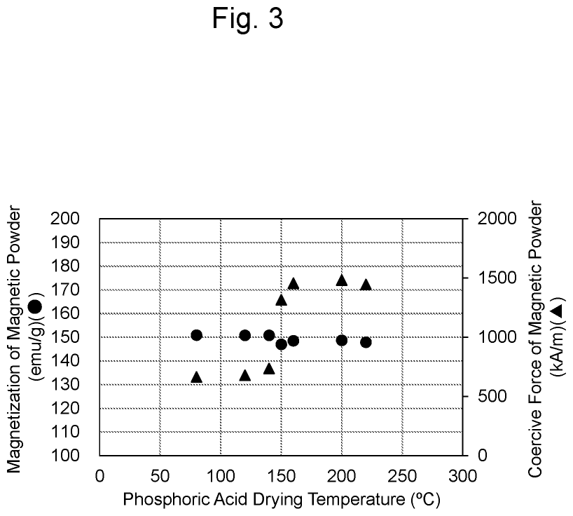

Changes in magnetizations and coercive forces in association with the changes in drying temperature regarding the obtained phosphoric acid-coated SmFeN-based anisotropic magnetic powders were examined. FIG. 3 indicates the results.

It was understood from FIG. 3 that, when the drying temperature of phosphoric acid was 150° C. or more, a phosphoric acid film reacts on the particle surface of the SmFeN-based anisotropic magnetic powder and forms a non-magnetic phase, thus enhancing the coercive force of the magnetic particles. When the drying temperature was 70° C. or less, water content contained in the particles was difficult to be removed. Therefore, since the reaction of phosphoric acid in the SmFeN-based anisotropic magnetic powder proceeds better at high temperature drying than at low temperature drying, it is considered that a large part of the particle surface of the powder at high temperature drying is covered with the phosphoric acid film.

Based on the above, with respect to the second SmFeN-based anisotropic magnetic powder having a small particle size and thus aggregating easily, since it is originally difficult to enhance the coercive force by a modification reaction with Zn, the coercive force is enhanced by the formation of a non-magnetic phase of phosphoric acid at high temperature drying in some embodiments. On the other hand, to enhance the coercive force by the modification reaction with Zn, the first SmFeN-based anisotropic magnetic powder having a large particle size is coated with phosphoric acid in a state where the particle surface has certain amounts of clearances formed by low temperature drying, and accelerates the modification reaction between Fe exposed at the clearances and Zn to enhance the coercive force in some embodiments.

### 2. Examination of Production of SmFeN-Based Rare Earth Magnet

### Comparative Example 1

(i) A first SmFeN-based anisotropic magnetic powder having a 50% particle size in a cumulative particle size distribution on a volumetric basis (D₅₀) of 3.1 μm, and a second SmFeN-based anisotropic magnetic powder having D₅₀ of 1.5 μm were prepared. D₅₀ of the SmFeN-based anisotropic magnetic powders were measured by a laser diffraction particle size distribution analyzer (HELOS & RODOS, manufactured by Japan Laser Corporation).
(ii) With respect to the first SmFeN-based anisotropic magnetic powder (large particles), 1 mass % of a phosphoric acid solution as PO₄ was introduced thereto, and after stirring for 5 minutes, solid-liquid separation was performed. Then, the obtained solid body was dried for 180 minutes in vacuum at a temperature of 200° C. to obtain a first phosphoric acid-coated SmFeN-based anisotropic magnetic powder.
(iii) With respect to the second SmFeN-based anisotropic magnetic powder (small particles), 1 mass % of a phosphoric acid solution as PO₄ was introduced thereto, and after stirring for 5 minutes, solid-liquid separation was performed. Then, the obtained solid body was dried for 180 minutes in vacuum at a temperature of 200° C. to obtain a second phosphoric acid-coated SmFeN-based anisotropic magnetic powder.
(iv) The first phosphoric acid-coated SmFeN-based anisotropic magnetic powder obtained in the step (ii), the second phosphoric acid-coated SmFeN-based anisotropic magnetic powder obtained in the step (iii), and metallic zinc (D₅₀: 0.5 μm, purity: 99.9 mass %) as a modifier powder containing Zn were dispersed and mixed under the condition of using a V-mixer at 60 rpm for 10 minutes to prepare a powder mixture. Note that the mass ratio between the first phosphoric acid-coated SmFeN-based anisotropic magnetic powder and the second phosphoric acid-coated SmFeN-based anisotropic magnetic powder (first phosphoric acid-coated SmFeN-based anisotropic magnetic powder:second phosphoric acid-coated SmFeN-based anisotropic magnetic powder) was 8.7:1.3, and the Zn amount was 7.5 mass % with respect to the total mass of the powder mixture.
(v) The powder mixture obtained in the step (iv) was compression molded for 1 minute in argon (Ar) gas atmosphere at room temperature (20° C.), in a magnetic field of 1194 kA/m, and under a pressure of 100 MPa to obtain a magnetic field molded body.
(vi) The magnetic field molded body obtained in the step (v) was pressure sintered in Ar gas atmosphere, at 380° C., under a pressure of 500 MPa, for 30 minutes to obtain a sintered body.
(vii) The sintered body obtained in the step (vi) was heat treated in vacuum, at 390° C., for 24 hours to obtain a SmFeN-based rare earth magnet.

### Comparative Example 2

A SmFeN-based rare earth magnet was produced in a manner similar to Comparative Example 1 except that the drying temperatures in the steps (ii) and (iii) in Comparative Example 1 were changed to 120° C. in both steps.

### Example 1

A SmFeN-based rare earth magnet was produced in a manner similar to Comparative Example 1 except that the drying temperatures in the step (ii) in Comparative Example 1 was changed to 120° C.

Production conditions of Comparative Examples 1 and 2, and Example 1 are summarized in Table 1.

TABLE 1

| | Phosphoric Acid | | | Magnetic Field Orientation | | | | | | | | | |
|---|---|---|---|---|---|---|---|---|---|---|---|---|---|
| | Drying | | | Molding Condition | | | | | | | | | |
| | Temperature | | | | Internal | | Pressure Sintering Condition | | | | Heat Treatment Condition | | |
| | Large | Small | Zn | | Magnetic | Molding | | Temper- | Molding | | | Temper- | |
| | Particles | Particles | Amount | Atmo- | Field | Pressure | Atmo- | ature | Pressure | Time | Atmo- | ature | Time |
| | (° C.) | (° C.) | (wt %) | sphere | (kA/m) | (MPa) | sphere | (° C.) | (MPa) | (min) | sphere | (° C.) | (h) |
| Comparative | 200 | 200 | 7.5 | Ar | 1194 | 100 | Ar | 380 | 500 | 30 | Vacuum | 390 | 24 |
| Example 1 | | | | | | | | | | | | | |
| Comparative | 120 | 120 | 7.5 | Ar | 1194 | 100 | Ar | 380 | 500 | 30 | Vacuum | 390 | 24 |
| Example 2 | | | | | | | | | | | | | |
| Example 1 | 120 | 200 | 7.5 | Ar | 1194 | 100 | Ar | 380 | 500 | 30 | Vacuum | 390 | 24 |

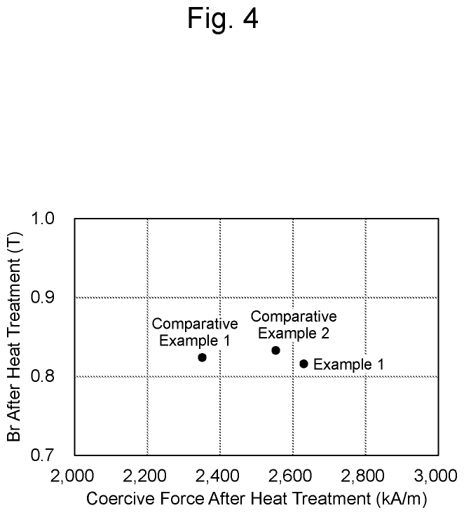

The coercive forces and the residual magnetic flux densities Br of the SmFeN-based rare earth magnets obtained in Comparative Examples 1 and 2, and Example 1 were measured. The results are summarized in Table 2 and FIG. 4.

TABLE 2

| | Phosphoric Acid | | | | | | | |
|---|---|---|---|---|---|---|---|---|
| | Drying | | | | | | | |
| | Temperature | | | Property After Heat Treatment | | | | |
| | Large | Small | Zn | | | | Coercive | |
| | Particles | Particles | Amount | Weight | Density | Br | Force | Orientation |
| | (° C.) | (° C.) | (wt %) | (g) | (g/cm³) | (T) | (kOe) | Degree |
| Comparative | 200 | 200 | 7.5 | 1.9651 | 5.59 | 0.824 | 2351 | 0.893 |
| Example 1 | | | | | | | | |
| Comparative | 120 | 120 | 7.5 | 1.9568 | 5.74 | 0.833 | 2553 | 0.885 |
| Example 2 | | | | | | | | |
| Example 1 | 120 | 200 | 7.5 | 1.7551 | 5.73 | 0.816 | 2630 | 0.871 |

Here, the residual magnetic flux density Br was evaluated using a DC magnetization magnetic flux meter (TRF), and a coercive force iHc was evaluated using a pulse excited magnetometer (TPM).

It was understood from Table 2 and FIG. 4 that, in Example 1, compared with Comparative Examples 1 and 2, the coercive force can be enhanced while maintaining Br.

In Comparative Example 1, the phosphoric acid film on the particle surface serves as a barrier, and the coercive force is expected to be enhanced by the formation of a non-magnetic phase of phosphoric acid. However, in both the first phosphoric acid-coated SmFeN-based anisotropic magnetic powder and the second phosphoric acid-coated SmFeN-based anisotropic magnetic powder, the modification reaction with Zn does not proceed easily and the coercive force is low. Meanwhile, in Comparative Example 2, while the phosphoric acid film is only partially present on the particle surface and the effect of enhancing the coercive force by the formation of a non-magnetic phase of phosphoric acid is small, the modification reaction between Fe exposed on the particle surface and Zn proceeds, and as a result, the coercive force becomes higher compared with that of Comparative Example 1. However, it is considered that, in the second SmFeN-based anisotropic magnetic powder as the small particles, aggregation occurs, and there are parts that are difficult to be in contact with Zn, that is, parts where the modification reaction does not proceed sufficiently. In Example 1, in the first SmFeN-based anisotropic magnetic powder as the large particles, the coercive force is expected to be enhanced by the modification reaction with Zn, and further, in the second SmFeN-based anisotropic magnetic powder as the small particles, the coercive force is expected to be enhanced by the formation of a non-magnetic phase of phosphoric acid. As a result, the coercive force of Example 1 becomes higher compared with those of Comparative Examples 1 and 2.

All publications, patents and patent applications cited in the present description are herein incorporated by reference as they are.

What is claimed is:

1. A method of producing a SmFeN-based rare earth magnet, comprising:
(i) a raw material preparing step of preparing a first SmFeN-based anisotropic magnetic powder having a 50% particle size in a cumulative particle size distribution on a volumetric basis (D₅₀) of 3.0±0.3 μm, and a second SmFeN-based anisotropic magnetic powder having D₅₀ of 1.6±0.3 μm;
(ii) a drying step of subjecting to a phosphoric acid source treatment and drying at a temperature of 80° C. or more and less than 150° C. with respect to the first SmFeN-based anisotropic magnetic powder to obtain a first phosphoric acid-coated SmFeN-based anisotropic magnetic powder;
(iii) a drying step of subjecting to a phosphoric acid source treatment and drying at a temperature of 150° C. or more and 250° C. or less with respect to the second SmFeN-based anisotropic magnetic powder to obtain a second phosphoric acid-coated SmFeN-based anisotropic magnetic powder;
(iv) a mixing step of mixing the first phosphoric acid-coated SmFeN-based anisotropic magnetic powder obtained in the step (ii), the second phosphoric acid-coated SmFeN-based anisotropic magnetic powder obtained in the step (iii), and a modifier powder containing Zn to prepare a powder mixture;
(v) a compression molding step of compression molding the powder mixture obtained in the step (iv) in a magnetic field to obtain a magnetic field molded body; and
(vi) a sintering step of pressure sintering the magnetic field molded body obtained in the step (v) to obtain a sintered body.

2. The method according to claim 1,
wherein, in the step (iv), a mass ratio between the first phosphoric acid-coated SmFeN-based anisotropic magnetic powder and the second phosphoric acid-coated SmFeN-based anisotropic magnetic powder (first phosphoric acid-coated SmFeN-based anisotropic magnetic powder:second phosphoric acid-coated SmFeN-based anisotropic magnetic powder) is 8:2 to 9:1.

3. The method according to claim 1,
wherein, in the step (ii), the temperature of drying is 80° C. or more and 140° C. or less.

4. The method according to claim 1,
wherein, in the step (iii), the temperature of drying is 160° C. or more and 220° C. or less.
